(19) United States
(12) Patent Application Publication
(10) Pub. No.: US 2026/0010718 A1
(43) Pub. Date: Jan. 8, 2026

(54) COMPUTING TECHNOLOGIES FOR USING LARGE LANGUAGE MODELS TO ENABLE MACHINE TRANSLATIONS FOLLOW SPECIFIC STYLE GUIDELINES

(71) Applicant: Smartling, Inc., New York, NY (US)

(72) Inventors: Mei Chai Zheng, Secaucus, NJ (US); Benjamin Loy, New York, NY (US)

(21) Appl. No.: 19/324,902

(22) Filed: Sep. 10, 2025

Related U.S. Application Data
(63) Continuation of application No. PCT/US2024/019679, filed on Mar. 13, 2024.
(60) Provisional application No. 63/451,882, filed on Mar. 13, 2023.

(51) Int. Cl. G06F 40/253; G06F 16/334; G06F 40/30; G06F 40/58

(52) U.S. Cl. CPC G06F 40/253; G06F 16/334; G06F 40/30; G06F 40/58

(57) ABSTRACT

This disclosure solves various technological problems described above by using large language models (LLMs) to enable translations, such as MTs, to follow specific style guidelines. Such improvements may be manifested by various outputs following specific style guidelines, such as register (e.g., formality versus informality), profanity usage, colloquialism preservation, tone of voice, or other suitable linguistics, as disclosed herein. Resultantly, these improvements improve computer functionality and text processing by enabling at least some customization and appropriateness of translated content for specific audiences and contexts. These technologies ensure that translations are not only accurate in terms of meaning of source texts but also in terms of cultural relevance and sensitivity.

### CROSS-REFERENCE TO RELATED PATENT APPLICATIONS

This patent application is a Continuation of a PCT International Application PCT/US2024/019679 filed 13 Mar. 2024; which claims a benefit of priority to U.S. Provisional Patent Application 63/451,882 filed 13 Mar. 2023; each of which is incorporated by reference herein for all purposes.

### TECHNICAL FIELD

This disclosure relates to large language models.

### BACKGROUND

Conventionally, many machine translation (MT) engines deploy generic MT models to create generic translations (e.g., from Russian language to English language). As such, style (e.g., formality) and tone (e.g., profanity), each of which is made up of multiple linguistic components, have slowly started being integrated into MT outputs, through customization of such MT models. However, certain MT engines are only able to provide standardized changes to accommodate the style and the tone. For example, certain MT engines tend to use one type of language register for all general translations, but may also end up mixing up language register in the MT outputs based on training corpuses (e.g. some sentences may address a user as “you formal” and some as “you informal” when translating from English language to Russian language). Therefore, currently, those MT engines have limited capabilities to address language registers. This state of being is made more technologically problematic when profanities are desired to be input into those MT engines. For example, some MT engines have only briefly dealt with a notion of profane content by replacing such content with a less severe language, choosing to not train those MT engines to output profane language. Such configurations often result in MT engines that omit profane language, and thereby change the style and the tone of the MT outputs relative to a source text that was requested to be translated.

With respect to style, many languages have specific styles for language registers (e.g., formal, informal) based on a type of communication, an intended audience, and a context in which this communication is received. Therefore, some MT engines may generate MT outputs with a notable bias or skew towards one register (e.g., formal), or sometimes even a mixture between several registers (e.g., formal and informal). This state of being may cause various technical problems for people who use MT for several reasons. For example, certain generic (or non-customized) MT engines do not correctly nor consistently distinguish between formal and informal outputs. Particularly, when translating large amounts of content that have been separated into smaller chunks (e.g., individual segments), there may be certain usage of formal and informal styles that is inconsistent or unpredictable. Likewise, certain languages may be structurally dependent on certain language registers (e.g., formal or informal) and such dependency may cause an entire sentence to be improperly translated, not only pronouns and verbs. Similarly, there is currently no known way to ensure formality in MT engines, because formality (I) cannot be easily defined through a set of standardized rules, (ii) is not always present in a sentence to be translated, (iii) is heavily language dependent, or (iv) is embedded in a syntax of a group of sentences, and not easily replaced through “blind search and replace,” which is how most MT engines approach these technical problems.

These technical problems are worsened when gendered terminology is encountered by MT engines. In particular, many languages have gendered nouns and titles (e.g., a doctor, a lawyer, a military rank) coming in a form of masculine and feminine. Some MT engines will often assume or default to masculine nouns and titles, due to biased training sets that often use these terms in a masculine form when no gender is specified. There is currently no known possibility of indicating if a noun or title should be masculine or feminine, causing some outputs to be incorrect in some cases. This state of being may be based on specific terminology in specific languages being neutral, while for other languages, there are gender specific versions, which may be generally applicable to professions or titles (e.g. a doctor, a governor, a mayor). Notably, in some situations, when referencing a person by a professional title, a sole way to properly translate the professional title of that person to a right gender may be through context awareness of an original content, which may not often be known by an MT engine being used. For example, when presented a document (e.g., an article) where a person (e.g., a doctor) is referred to as a female in a female form in a beginning portion of the document, the MT engine is generally not able to continue to recognize that need to use the female form of the professional title (e.g., a doctor) through a remainder of the document, other than (exception cases) when context is provided in that same string or a first name is presented with a specific expected gender for that name (e.g., Kevin is usually male and Samantha is usually female). Additionally, if a last name is alone in conjunction with a professional title (e.g., a military rank, a professor), then the MT engine may not easily derive gender based on the last name alone. Likewise, since some first names can be used for both genders (e.g., Alex, Ariel), the MT engine may be inaccurate to determine a gender on the basis of a first name alone. Therefore, some MT engines are not ideal for translating language, where gender needs to be taken into consideration as part of a translation output, as those engines do not understand such differences. For example, some MT engines may not correctly distinguish between gender specific terms or phrases, if there is no indication thereof in the source text. Likewise, some MT engines may assume or default to male forms, if no guidance is given through pronouns and gendered titles in the source text. Similarly, some MT engines may be biased towards specific genders (e.g., male forms are output for traditional male roles and female forms are output for traditional female roles). Moreover, some MT engines may not allow some inputs to specify gender form. Additionally, some MT engines may not output possible gender neutral formation of normally gendered terms (e.g., chairperson instead of chairman or chairwoman).

These technical problems are also worsened when certain colloquial expressions, idioms, and proverbs are encountered by some MT engines. In particular, certain colloquial expressions, idioms, and proverbs are difficult to translate, and often, are culturally specific, which can also be linked in some way to linguistic expressions and regions those colloquial expressions, idioms, and proverbs originate from. For example, although some colloquial expressions and idioms can be comprehended and relevant in one geographical region, but not in another one, even if those two geographical regions speak one language (e.g., United States of America and United Kingdom). Also, proverbs, although mostly “universal,” have a tendency to be more well known in specific geographic regions. Because these phrases and sentences are constructed to have a secondary, hidden meaning that is culturally and locally bound, translating this type of content accurately is difficult. This may occur because certain MT engines will translate colloquial expressions, idioms, and proverbs literally, rather than finding similar expressions, idioms or proverbs, thereby drastically changing meanings that are intended to be conveyed. Consequently, certain users who may want to preserve colloquial expressions, idioms, and proverbs may not be able to use MT to fulfill their translation needs due to poor and literal translation outputs.

These technical problems are additionally worsened when an active voice and a passive voice, especially in contrast, are encountered. In particular, the active voice and the passive voice can change an expression of a source content and occasionally a source meaning as well. Often, a human translator may be explicitly instructed to use the active voice or the passive voice during translation per a set of style guide recommendations for a respective language. In certain languages, the active voice or the passive voice may change a language register of communication and can imply different meanings for a reader (e.g., a lack of respect). Therefore, retaining a desired voice, whether active or passive, in the MT outputs is important. In many cases, the MT models may translate literally and not consider whether that content should be recited in the active voice or the passive voice, leaving such modifications to a human linguist in a post-MT processing phase, which may be laborious. This state of being often leads to translations being good enough to be understood, but stylistically irrelevant, causing readers to question whether the MT outputs are of sound quality.

These technical problems are further worsened when an abbreviation is encountered. In particular, certain abbreviations are commonplace in specific types of text, such as ex., i.e., e.g., etc. This type of short hand is often used to shorten a source content (e.g., when word limits exist) and quickly add additional meaning to sentences. However, because abbreviations are often language dependent and not easily translated from one language to the other, certain MT engines may often unabbreviate (or expand) the abbreviations and then directly translate those. There is no currently known replacement of a translation to use an equal type of abbreviation in a target language. Such lack of a choice for abbreviations can often cause confusion in the MT outputs, where the MT engines have to decide (often wrongly) how to translate an abbreviation.

With respect to tone, profanity is often evolving and its acceptance of use and degree thereof varies per language and context. Most languages have different ways of expressing profanity when profanity is embedded in a meaning of a content being translated. As such, users are not always looking to remove profanity from their content or want to preserve the meaning without using specific words. This state of being causes various technical problems. For example, some MT engines (i) often strip out profanity during translation to return a more “normalized” translation, (ii) have difficulty keeping profane content in a common tone of voice, (iii) translate profanity out of context and cannot ensure correct semantics, (iv) do not work well with idiomatic phrasing, losing a source linguistic meaning in translation-often offering direct translations, (v) work with profanity and often incorrectly/inappropriately change what is meant and end up producing offensive content or more profane content, (vi) cannot distinguish between different levels of profanity in different languages and cultural contexts, or (vii) are not consistent in handling profanity, leading to inconsistent translations, which can prove to be especially problematic with larger blocks of content.

### SUMMARY

This disclosure solves various technological problems described above by using large language models (LLMs) to enable translations, such as MTs, to follow specific style guidelines. Such improvements may be manifested by various outputs following specific style guidelines, such as register (e.g., formality versus informality), profanity usage, colloquialism preservation, tone of voice, or other suitable linguistics, as disclosed herein. Resultantly, these improvements improve computer functionality and text processing by enabling at least some customization and appropriateness of translated content for specific audiences and contexts. These technologies ensure that translations are not only accurate in terms of meaning of source texts but also in terms of cultural relevance and sensitivity.

There may be an embodiment comprising a system programmed as described herein. For example, the system may comprise: a computing instance programmed to: (i) submit a source text, a source locale identifier, a target locale identifier, a source style guide identifier, and a target style guide identifier to a data source, such that the data source outputs a first expectation identifier for a first linguistic feature in a target language and a second expectation identifier for a second linguistic feature in the target language based on the source text, the source locale identifier, the target locale identifier, the source style guide identifier, and the target style guide identifier; (ii) access a target text translated from the source text; (iii) determine whether (a) a first style guide associated with the first expectation identifier is assigned to the target locale identifier and (b) the target text is not compliant with the first style guide; (iv) based on (a) the first style guide being determined to be assigned to the target locale identifier and (b) the target text being determined to not be compliant with the first style guide: input the source text, the target text, the first expectation identifier, and a first instruction into an LLM, such that the LLM outputs the target text modified according to the first style guide for the first linguistic feature based on the first instruction to be consistent with the first expectation identifier; determine whether (a) a second style guide associated with the second expectation identifier is assigned to the target locale identifier and (b) the target text modified according to the first style guide is not compliant with the second style guide; based on (a) the second style guide being determined to be assigned to the target locale identifier and (b) the target text modified according to the first style guide being determined to not be compliant with the first style guide: input the source text, the target text modified according to the first style guide, the second expectation identifier, and a second instruction into the LLM, such that the LLM outputs the target text modified according to the first style guide and further modified according to the second style guide for the second linguistic feature based on the second instruction to be consistent with the second expectation identifier; (v) based on (a) the first style guide being determined to not be assigned to the target locale identifier or (b) the target text being determined to be compliant with the first style guide: determine whether (a) the second style guide is assigned to the target locale identifier and (b) the target text is not compliant with the second style guide; based on (a) the second style guide being determined to be assigned to the target locale identifier and (b) the target text being determined to not be compliant with the second style guide: input the source text, the target text, the second expectation identifier, and the second instruction into the LLM, such that the LLM outputs the target text modified according to the second style guide for the second linguistic feature based on the second instruction to be consistent with the second expectation identifier.

There may be an embodiment comprising a method programmed as described herein. For example, the method may comprise: (i) submitting, via a computing instance, a source text, a source locale identifier, a target locale identifier, a source style guide identifier, and a target style guide identifier to a data source, such that the data source outputs a first expectation identifier for a first linguistic feature in a target language and a second expectation identifier for a second linguistic feature in the target language based on the source text, the source locale identifier, the target locale identifier, the source style guide identifier, and the target style guide identifier; (ii) accessing, via the computing instance, a target text translated from the source text; (iii) determining, via the computing instance, whether (a) a first style guide associated with the first expectation identifier is assigned to the target locale identifier and (b) the target text is not compliant with the first style guide; (iv) based on (a) the first style guide being determined to be assigned to the target locale identifier and (b) the target text being determined to not be compliant with the first style guide: inputting, via the computing instance, the source text, the target text, the first expectation identifier, and a first instruction into an LLM, such that the LLM outputs the target text modified according to the first style guide for the first linguistic feature based on the first instruction to be consistent with the first expectation identifier; determining, via the computing instance, whether (a) a second style guide associated with the second expectation identifier is assigned to the target locale identifier and (b) the target text modified according to the first style guide is not compliant with the second style guide; based on (a) the second style guide being determined to be assigned to the target locale identifier and (b) the target text modified according to the first style guide being determined to not be compliant with the first style guide: inputting, via the computing instance, the source text, the target text modified according to the first style guide, the second expectation identifier, and a second instruction into the LLM, such that the LLM outputs the target text modified according to the first style guide and further modified according to the second style guide for the second linguistic feature based on the second instruction to be consistent with the second expectation identifier; (v) based on (a) the first style guide being determined to not be assigned to the target locale identifier or (b) the target text being determined to be compliant with the first style guide: determining, via the computing instance, whether (a) the second style guide is assigned to the target locale identifier and (b) the target text is not compliant with the second style guide; based on (a) the second style guide being determined to be assigned to the target locale identifier and (b) the target text being determined to not be compliant with the second style guide: inputting, via the computing instance, the source text, the target text, the second expectation identifier, and the second instruction into the LLM, such that the LLM outputs the target text modified according to the second style guide for the second linguistic feature based on the second instruction to be consistent with the second expectation identifier.

There may be an embodiment comprising a storage medium programmed as described herein. For example, the storage medium may store a set of instructions executable by a computing instance to perform a method, wherein the method may comprise: (i) submitting, via a computing instance, a source text, a source locale identifier, a target locale identifier, a source style guide identifier, and a target style guide identifier to a data source, such that the data source outputs a first expectation identifier for a first linguistic feature in a target language and a second expectation identifier for a second linguistic feature in the target language based on the source text, the source locale identifier, the target locale identifier, the source style guide identifier, and the target style guide identifier; (ii) accessing, via the computing instance, a target text translated from the source text; (iii) determining, via the computing instance, whether (a) a first style guide associated with the first expectation identifier is assigned to the target locale identifier and (b) the target text is not compliant with the first style guide; (iv) based on (a) the first style guide being determined to be assigned to the target locale identifier and (b) the target text being determined to not be compliant with the first style guide: inputting, via the computing instance, the source text, the target text, the first expectation identifier, and a first instruction into an LLM, such that the LLM outputs the target text modified according to the first style guide for the first linguistic feature based on the first instruction to be consistent with the first expectation identifier; determining, via the computing instance, whether (a) a second style guide associated with the second expectation identifier is assigned to the target locale identifier and (b) the target text modified according to the first style guide is not compliant with the second style guide; based on (a) the second style guide being determined to be assigned to the target locale identifier and (b) the target text modified according to the first style guide being determined to not be compliant with the first style guide: inputting, via the computing instance, the source text, the target text modified according to the first style guide, the second expectation identifier, and a second instruction into the LLM, such that the LLM outputs the target text modified according to the first style guide and further modified according to the second style guide for the second linguistic feature based on the second instruction to be consistent with the second expectation identifier; (v) based on (a) the first style guide being determined to not be assigned to the target locale identifier or (b) the target text being determined to be compliant with the first style guide: determining, via the computing instance, whether (a) the second style guide is assigned to the target locale identifier and (b) the target text is not compliant with the second style guide; based on (a) the second style guide being determined to be assigned to the target locale identifier and (b) the target text being determined to not be compliant with the second style guide: inputting, via the computing instance, the source text, the target text, the second expectation identifier, and the second instruction into the LLM, such that the LLM outputs the target text modified according to the second style guide for the second linguistic feature based on the second instruction to be consistent with the second expectation identifier.

### DESCRIPTION OF DRAWINGS

FIG. 1 shows a diagram of an embodiment of a computing architecture according to this disclosure.

FIG. 2 shows a flowchart of an embodiment of an algorithm for a stylistic transformation according to this disclosure.

FIG. 3 shows a diagram of an embodiment of a data structure for a style guide according to this disclosure.

FIG. 4 shows a flowchart of an embodiment of an algorithm for receiving a translation according to this disclosure.

### DETAILED DESCRIPTION

As explained above, this disclosure solves various technological problems described above by using LLMs to enable translations, such as MTs, to follow specific style guidelines. Such improvements may be manifested by various outputs following specific style guidelines, such as register (e.g., formality versus informality), profanity usage, colloquialism preservation, tone of voice, or other suitable linguistics, as disclosed herein. Resultantly, these improvements improve computer functionality and text processing by enabling at least some customization and appropriateness of translated content for specific audiences and contexts. These technologies ensure that translations are not only accurate in terms of meaning of source texts but also in terms of cultural relevance and sensitivity. This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

As used herein, a term “locale” refers to a standard language locale definition but where a language identifier (e.g., en, es) is required and a region identifier (e.g., US, ES) is optional.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have the same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

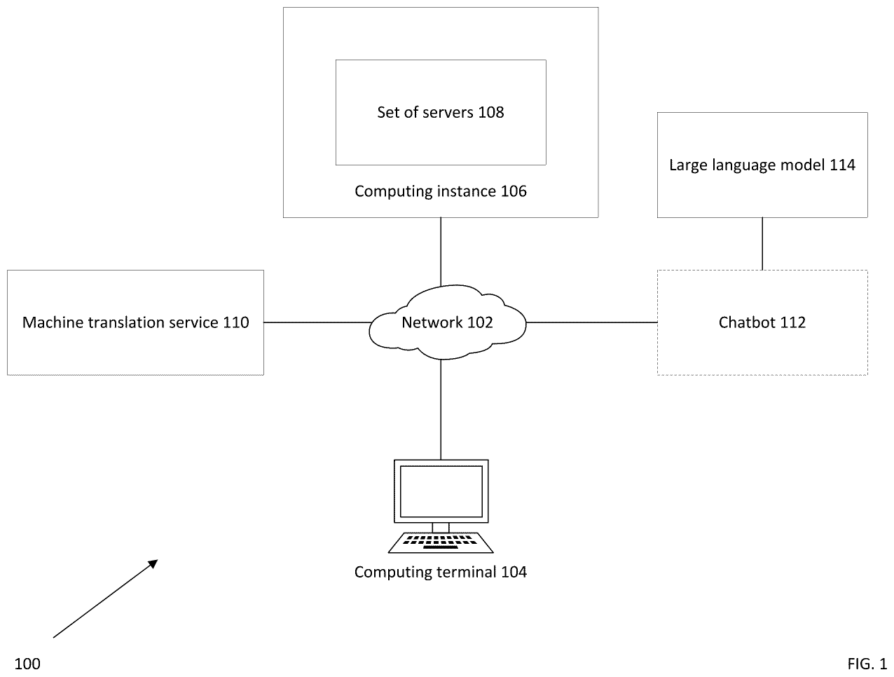

FIG. 1 shows a diagram of an embodiment of a computing architecture according to this disclosure. In particular, there is a computing architecture 100 containing a network 102, a computing terminal 104, a computing instance 106, an MT service 110, a chatbot 112, and an LLM 114. The computing instance 106 contains a server or set of servers 108. The chatbot 112 is optional and may be omitted.

The network 102 is a wide area network (WAN), but may be a local area network (LAN), a cellular network, a satellite network, or any other suitable network. For example, the network 102 is Internet. Although the network 102 is illustrated as a single network 102, this configuration is not required and the network 102 can be a group or collection of suitable networks collectively operating together in concert to accomplish various functionality, as disclosed herein.

The computing terminal 104 is a desktop computer, but may be a laptop computer, a tablet computer, a wearable computer, a smartphone, or any other suitable computing form factor. The computing terminal 104 hosts an operating system (OS) and an application program on the OS. For example, the OS may include Windows, MacOS, Linux, or any other suitable OS. Likewise, the application program may be a browser program (e.g., Microsoft Edge, Apple Safari, Mozilla Firefox), an enterprise content management (ECM) program, a content management system (CMS) program, a customer relationship management (CRM) program, a marketing automation platform (MAP) program, a product information management (PIM) program, and a translation management system (TMS) program, or any other suitable application, which is operable (e.g., interactable, navigable) by a user of the computing terminal 104. The computing terminal 104 may be in communication (e.g., wired, wireless, waveguide) with the computing instance 106, the MT service 110, the chatbot 112, or the LLM 114 over the network 102. For example, such communication may occur via the application program running on the OS, as explained above. The computing terminal 102 is separate and distinct from the computing instance 106, the MT service 110, the chatbot 112, or the LLM 114.

The computing instance 106 is a computing service or unit containing the server (e.g., physical or virtual) or the set of servers 108 (e.g., physical or virtual) programmatically acting in concert, any of which may be a web server, an application server, a database server, or another suitable server, to enable various algorithms disclosed herein. For example, via the server or the set of servers 108, the computing instance 106 may be enabled in a cloud computing service (e.g., Amazon Web Services (AWS)) as a service-oriented-architecture (SOA) backend technology stack having a plurality of services that are interconnected via various application programming interfaces (APIs), to enable various algorithms disclosed herein, any of which may be internal or external to the computing instance 106. For example, some of such APIs may have, call, or instantiate representational state transfer (REST) or RESTful APIs integrations or some of services may have, instantiate, or call some data sources (e.g., databases, relational databases, database services, relational database services, graph databases, in-memory databases, RDS, S3, Kafka) to persist data, as needed, whether internal to the computing instance 106 or external to the computing instance 106, to enable various algorithms disclosed herein. For example, the computing instance 106 may host or run an application program, which may be distributed, on the SOA hosting, deploying, calling, or accessing the services that are interconnected via the APIs, to enable various algorithms disclosed herein. For example, the computing instance 106 (e.g., an application program) may have, host, call, or instantiate a style guide service, whether internal to the computing instance 106 or external to the computing instance 106, to enable various algorithms disclosed herein. For example, the style guide service may have, host, call, or instantiate a cloud service, whether internal or external to the computing instance 106, that has a database (e.g., relational, graph, in-memory, NoSQL), whether internal or external to the computing instance 106, containing a set of multilingual style guides for a set of users requesting translations, whether internal to the computing instance 106 or external to the computing instance 106, to enable various algorithms disclosed herein. The cloud service may have a number of REST APIs to execute create, update, read, and delete (CRUD) operations to maintain the database and a number of other APIs to do tasks involving taking text and returning terms that are present within a text (e.g., unstructured, structured) being translated and return translations (e.g., unstructured, structured) of those terms, to enable various algorithms disclosed herein. The style guide service may include a set of style guide unique identifiers (UIDs) to partition certain style guides into different content groups that can be accessed independently of each other, to enable various algorithms disclosed herein. For example, the computing instance 106 may use the set of style guide UIDs to determine which style guide data structures (e.g., a database, a record, a field, a row, a column, a table, an array, a tree, a graph, a file, a data file, a text file) to use for generating a set of style guide rules, as disclosed herein. The computing instance 106 may be in communication (e.g., wired, wireless, waveguide) with the computing terminal 104, the MT service 110, the chatbot 112, or the LLM 114 over the network 102. For example, such communication may occur via the (SOA) backend technology stack or the style guide service, as explained above. The computing instance 106 is separate and distinct from the computing terminal 104, the MT service 110, the chatbot 112, or the LLM 114. However, such configurations may vary. For example, the computing instance 106 may internally host the MT service 110, the chatbot 112, or the LLM 114.

The MT service 110 is a network-based MT service that instantly translates words, phrases, and web pages between at least two languages (e.g., English and Hebrew). For example, the MT service 110 may be running on a server or a set of servers (e.g., physical or virtual) acting in concern to host an MT engine (e.g., a task-dedicated executable logic that can be started, stopped, or paused) having a neural machine translation (NMT) logic. For example, the MT service 110 may be Google Translate, Bing Translator, Yandex Translate, or another suitable network-based MT service. The MT service 110 may be in communication (e.g., wired, wireless, waveguide) with the computing terminal 104, the computing instance 106, the chatbot 112, or the LLM 114 over the network 102. For example, such communication may occur via the MT engine, as explained above. The MT service 110 is separate and distinct from the computing terminal 104, the computing instance 106, the chatbot 112, or the LLM 114. However, such configurations may vary. For example, the MT service 110 may internally host the computing instance 106, the chatbot 112, or the LLM 114.

The chatbot 112 is a computer program that simulates human conversation, allowing interaction through text or voice. The chatbot 112 can handle various tasks, which may range from answering customer queries to providing support or automating processes. The chatbot 112 can be a scripted or quick reply chatbot, a keyword recognition-based chatbot, a hybrid chatbot, a contextual chatbot, a voice chatbot, or another suitable chatbot form factor. For example, the chatbot 112 may be ChatGPT, Google Gemini, Microsoft Copilot, or another suitable chatbot. The chatbot 112 may be in communication (e.g., wired, wireless, waveguide) with the computing terminal 104, the computing instance 106, the MT service 110, or the LLM 114 over the network 102. The chatbot 112 is separate and distinct from the computing terminal 104, the computing instance 106, the MT service 110, or the LLM 114. However, such configurations may vary. For example, the chatbot 112 may directly communicate with the LLM 114 or internally host the LLM 114, to be operated thereby. Alternatively, the LLM 114 may directly communicate with the chatbot 112 or internally host the chatbot 112, to enable the chatbot 112 to be operated thereby. Additionally, the computing instance 106 or the MT service 110 may internally host the chatbot 112, whether the chatbot 112 is separate and distinct from the LLM 114 or not, as explained above. Note that the chatbot 112 is optional and may be omitted.

The LLM 114 may be a language model (e.g., a generative artificial intelligence (AI) model, a generative adversarial network (GAN) model, a generative pre-trained transformer (GPT) model) including an artificial neural network (ANN) with a set of parameters (e.g., tens of weight, hundreds of weights, thousands of weights, millions of weights, billions of weights, trillions of weights), initially trained on a quantity of unlabeled content (e.g., text, unstructured text, descriptive text, imagery, sounds) using a self-supervised learning algorithm or a semi-supervised learning algorithm or an unsupervised learning algorithm to understand a set of corresponding data relationships. Then, the LLM 114 may be further trained by fine-tuning or refining the set of corresponding data relationships via a supervised learning algorithm or a reinforcement learning algorithm. Once the LLM 114 is trained, the LLM 114 is structured to have a data structure and organized to have a data organization. As such, the data structure and the data organization collectively enable the LLM 114 to perform various algorithms disclosed herein. For example, the LLM 114 may be a general purpose model, which may excel at a range of tasks (e.g., generating a content for a user consumption) and may be prompted, i.e., programmed to receive a prompt (e.g. a request, a command, a query), to do something or accomplish a certain task. The LLM 114 may be embodied as or accessible via a ChatGPT AI chatbot, a Google Gemini AI chatbot, or another suitable LLM. The LLM 114 may be prompted by the computing terminal 104, the computing instance 106, or the MT service 110, whether directly or indirectly. For example, the computing instance 106 may be programmed to engage with the LLM 114 over the network 102, whether through the chatbot 112 or without the chatbot 112, to perform various algorithms disclosed herein. Alternatively, the computing instance 106 may internally host the LLM 114 and programmed to engage with the LLM 114, to perform various algorithms disclosed herein. Such forms of engagement may include inputting a text (e.g., structured or unstructured) into the LLM 114 in a human-readable form, for the LLM 114 to output a content (e.g., a text, a structured text, an unstructured text, a descriptive text, an image, a sound), i.e., to do something or accomplish a certain task. Note that the LLM 114 can be scaled down into a small language model (SLM) or the SLM can be a miniatured or less complex version of the LLM 114, which can trained on less data and fewer parameters than the LLM 114. As such, various algorithms disclosed herein can use the SLM as the LLM 114, as disclosed herein.

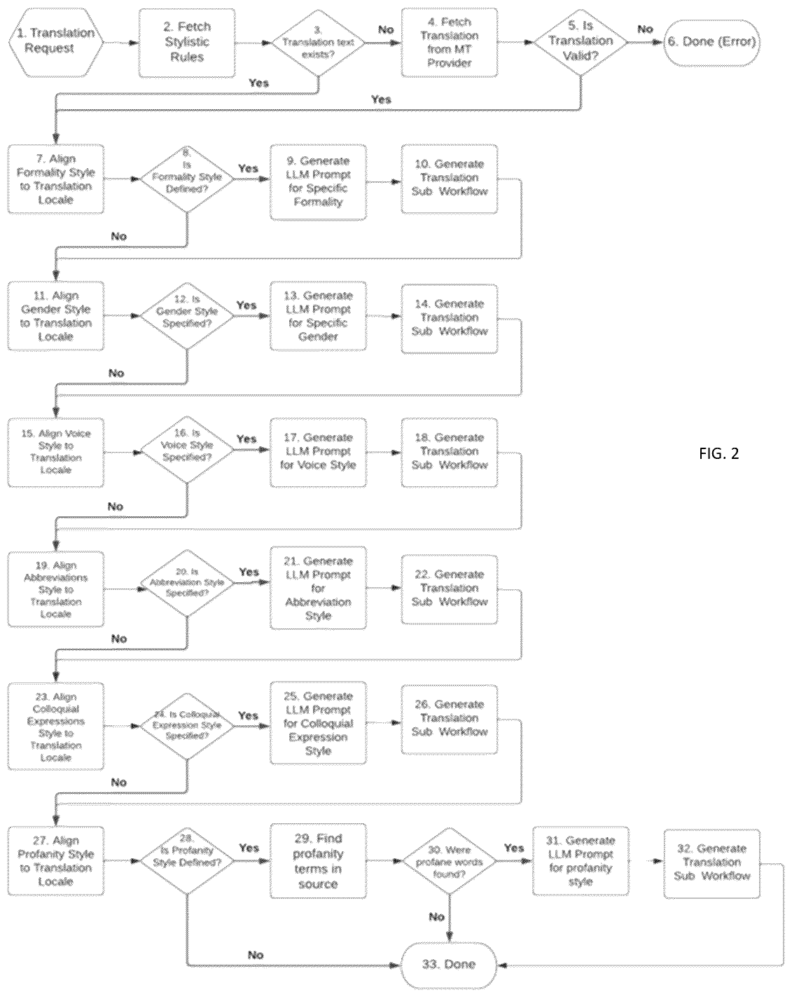

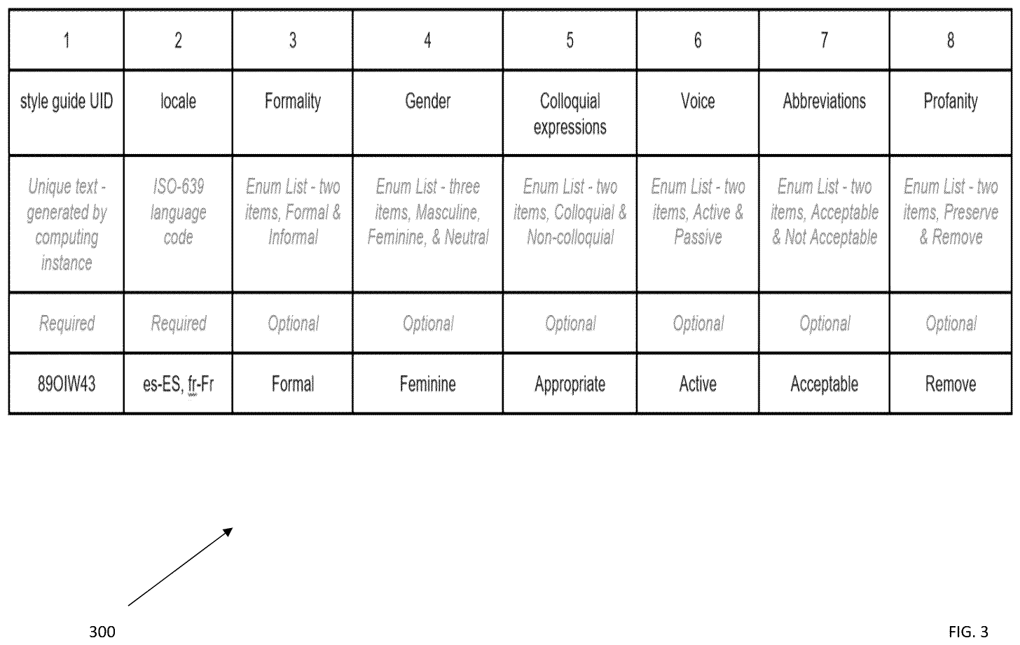

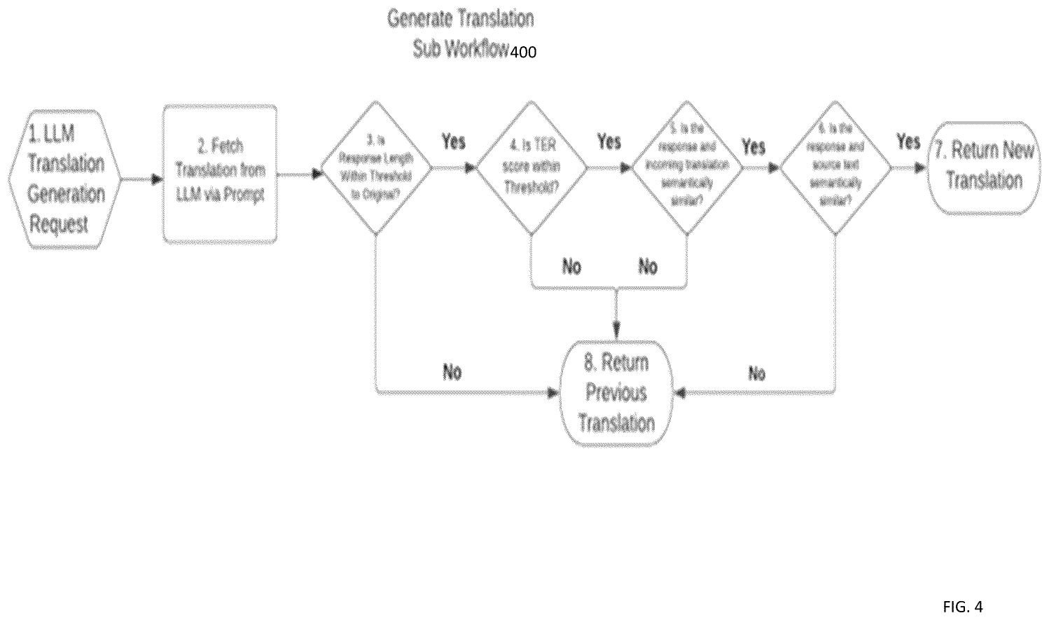

FIG. 2 shows a flowchart of an embodiment of an algorithm for a stylistic transformation according to this disclosure. FIG. 3 shows a diagram of an embodiment of a data structure for a style guide according to this disclosure. FIG. 4 shows a flowchart of an embodiment of an algorithm for receiving a translation according to this disclosure. In particular, there is a method 200 enabling an algorithm for a stylistic transformation using the computing architecture 100 shown in FIG. 1, a data structure 300 for a style guide shown in FIG. 3, and a method 400 enabling an algorithm for receiving a translation according to this disclosure. The method 200, the data structure 300, and the method 400 collectively enable translations, such as MTs, to follow specific style guidelines by looping or iteration on a per style basis, as shown in FIG. 2 for groups of steps 7-10, 11-14, 15-18, 19-22, 23-26, and 27-32, which may occur in any permutational order, which may vary per implementation (e.g., per language, per source text, per target text). Such improvements may be manifested by various outputs following specific style guidelines, such as register (e.g., formality versus informality), profanity usage, colloquialism preservation, tone of voice, or other suitable linguistics, as disclosed herein. Resultantly, these improvements improve computer functionality and text processing by enabling at least some customization and appropriateness of translated content for specific audiences and contexts. These technologies ensure that translations are not only accurate in terms of meaning of source texts but also in terms of cultural relevance and sensitivity.

The method 200 has steps 1-33, which may be performed by the computing instance 106 (e.g., an application program). As such, in order to ensure that an MT adheres to a stylistic guideline, the computing instance 106 may send a target text (e.g., structured, unstructured), translated by the MT service 110 from a source text (e.g., structured, unstructured), to the LLM 114, whether internal or external to the computing instance 106, along with an instruction for a formality content or a profanity content, and request the LLM 114 to return a corrected translation of the target text, where the computing instance 106 may perform steps 1-33, as further explained below. Although FIG. 2 shows one sequence of the process 200, note that this sequence is not required and other sequences are possible. For example, although steps 7, 11, 15, 19, 23, and 27 and their respective set of sub-steps 8-10, 12-14, 16-18, 20-22, 24-26, and 28-32, are recited according a certain order for performing a stylistic analysis, note that this order is not required. For example, step 23 and its sub-steps 24-26 can occur before step 7 and its sub-steps 8-10. Other suitable variations of such order are possible. For example, step 27 and its sub-steps 28-32 can occur before step 19 and its sub-steps 20-22.

Step 1 involves the computing instance 106 receiving a translation request from the computing terminal 104 over the network 102. The translation request includes a source text, a source locale identifier (ID), a target locale ID, a set of MT provider credentials and metadata, and a set of glossary unique identifiers (UIDs). For example, the source text may be an original text that needs to be translated, the target text may be an output text that has been translated from the source text, the source or target local may include language and regional information, such as Spanish for Mexico (es-MX), and the source or target ID may be an International Standards Organization (ISO) code to define and determine a locale.

The source text may be structured, such as a JavaScript Objection Notation (JSON) content, an extensible Markup Language (XML) content, a Darwin Information Typing Architecture (DITA) content, or another suitable structured content. The source text may be unstructured, such as descriptive content, natural language content, or any other suitable unstructured content. The source text is an input text to be translated. For example, the input text may include an unstructured text or descriptive text (e.g., an article, a legal document, a patent specification) contained in a data structure (e.g., a file, a data file, a text file, an email message). For example, the source text may be in a string, which may be a sentence or another suitable linguistic form factor (e.g., a set of sentences, a paragraph).

The source locale ID may be a modified ISO-639 (or another standard) language code (e.g., en, es) and a modified ISO-3166 country code (e.g., US, ES) representing a source text locale (e.g., ru-RU or es-MX).

The target locale ID may be a modified ISO-639 (or another standard) language code (e.g., en, es) and a modified ISO-3166 country code (e.g., US, US) representing a desired locale to use for translation (e.g., en-US or es-MX).

The set of MT provider credentials and metadata may include a name of a MT service provider to use (e.g., Google MT engine, Microsoft MT engine, DeepL MT engine) by the computing instance 106. For example, the name of the MT service provider may be identified by an identifier (e.g., an alphanumeric string). The set of MT provider credentials and metadata may include a set of MT service provider credentials to interact with the MT service provider (e.g., a login and a password). The set of MT provider credentials and metadata may include a set of MT service provider specific metadata to control various aspects of a translation process (e.g., a custom model).

The set of style guide UIDs may be used by the computing instance 106 to determine which style guide data structures (e.g., a database, a table, a record, a field, an array, a tree, a graph) to use by the computing instance 106 to inform of translation style. For example, one style guide data structure may be for Spanish and another style guide data structure may be for Hebrew. For example, one style guide data structure may be for one type of content (e.g., industry, formality, marketing, life science, computing, legal) and another style guide data structure may be for another type of content (e.g., industry, formality, marketing, life science, computing, legal).

One example of a style guide (e.g., an instruction for an expected tone, voice and style for an output text) data structure is shown in FIG. 3 as the data structure 300 showing relevant fields used in the method of FIG. 2. Columns 3-8 are repeated per specified locale that is present in the data structure 300 based on desired, but can vary or be adapted for any languages (e.g., English, Spanish, French, Russian, German, Italian, Greek, Azeri, Armenian, Georgian, Turkish, Hebrew, Arabic, Mandarin, Cantonese, Urdu, Bengali). The data structure 300 has various data points, which may be organized (e.g., related to each other) via a primary key for use by the computing instance 106. The style guide UID field contains is a unique identifier generated by the computing instance 106 to identify a specific style guide. For example, the style guide UID may be a primary key by which other data points are accessible. The locale field contains a set of locale IDs (e.g., source and target) in which this style guide should apply to. Note that such selection of a language is illustrative and can vary based on a desired translation. The formality field contains a formality identifier for an expected formality in a final output text, where the user can select between a formal expected formality and an informal expected formality. Note that such selection is illustrative and can vary based on a desired translation. The gender field contains a gender identifier for an expected gender of a subject in a specific text, where the gender identifier can be made feminine, masculine, or neutral. Note that such selection is illustrative and can vary based on a desired translation. The colloquial expression field contains a colloquial expression identifier for an expected colloquial expression to be used in a final output text, where the user can select between a colloquial statement or a non-colloquial statement. Note that such selection is illustrative and can vary based on a desired translation. The voice field contains a voice identifier for an expected voice in a final output text, where the user can select between an active voice and a passive voice. Note that such selection is illustrative and can vary based on a desired translation. The abbreviations field contains an abbreviation identifier for an expected use of an abbreviation in a final output text, where the user can select between an acceptable use of abbreviations or an unacceptable use of abbreviations. Note that such selection is illustrative and can vary based on a desired translation. The profanity field contains a profanity identifier for an expectation of a preservation of a profanity or a removal thereof, with an additional replacement of a summarized non-profane version of a content. Note that such selection is illustrative and can vary based on a desired translation. As such, the data structure 300 showing relevant fields used in the method of FIG. 2 may be exemplified in FIG. 3 or adapted as needed per languages involved and per desired translation style.

Step 2 involves the computing instance 106 fetching stylistic rules. This fetching may occur by the computing instance 106 making a call to an API (e.g., a REST API) to the style guide service with the source text, the source locale ID, the target locale ID, and the set of style guide UIDs (e.g., one UID for source style guide data structure and one UID for target style guide data structure). In reply, the computing instance 106 receives a response from the API, where the response contains an expectation for formality (e.g., formal, informal, not available, not applicable), an expectation for gender (e.g., feminine, masculine, gender neutral, not available, not applicable), an expectation for colloquial expressions (e.g., appropriate, inappropriate, not available, not applicable), an expectation for voice (e.g., active, passive, not available, not applicable), an expectation for abbreviations (e.g., acceptable, unacceptable, not available, not applicable), and an expectation for profanity (e.g., with profanity, without profanity, not available, not applicable). At that time, the response (e.g., a collection of style expectations) may be passed to a next step. If there is an error with the call to the API, then the method 200 may continue with an empty collection of style expectations.

Step 3 involves the computing instance 106 determining whether a translation text exists. Therefore, if the translation text from step 1 or step 2 exists, then perform step 7 (e.g., skip interacting with the MT service 110). However, if the translation text from step 1 or step 2 does not exist, then perform step 4.

Step 4 involves the computing instance 106 fetching a translation from the MT service 110. These operations may include calling the MT service 110 that corresponds to the name of the MT service provider in the input (e.g., based on identifier). Note there may be multiple MT services 110, each configured differently from others, or operated by different entities. In response, the MT service 110 may execute various forms of transformations on the source text that is appropriate for the MT service 110. These transformations may include (i) escaping the source text characters to be in a proper content type format for the MT service 110 (e.g., hypertext markup language (HTML)), (ii) splitting the source text based on length and text characteristics, like tags, punctuation, and sentence delimiters, (iii) identifying portions of the source text that is configured to not be translated and wrapping those parts of the text in control text/tags (e.g., specific html no-translate tags), or other suitable transformations. The MT service 110 may take the credentials and metadata, as mentioned above, and creates a valid API call(s) to that MT service 110 containing that data with the modified source text as input. The MT service 110 may return a response, where (i) if a non-200 status code HTTP code response (or another suitable response), then continue with a blank translation, or (ii) if a 200 status code HTTP response (or another suitable response), then get (e.g., copy, download) the translation from the response. The MT service 100 may reverse the source text transformations from above, which may include (i) removing control text/tags that are in the translation, (ii) combining the split translation texts into a single translation text (e.g., append), (iii) unescaping (or decoding) the text based on how the source text was escaped (or encoded), or other suitable reversals. The translation from the MT service 110 can be copied to be used downstream, as disclosed herein. For example, as shown below, a SourceText was sent to the MT service 110 and a TranslationText was returned, as exemplified below

| | |
|---|---|
| SourceText | ‘You are an awesome leader for Singapore.’ |
| TranslationText | [symbol] |

Step 5 involves the computing instance 106 determining whether the translation received from the MT service 110 is valid, i.e., performing validation. If not, then step 6 is performed. If yes, then step 7 is performed. For example, such validation may include determining by the computing instance 106 whether the translation is (e.g., invalid) or is not blank (e.g., valid). As such, for an example presented above, the TranslationText passes such validation.

Step 6 involves the computing instance 106 generating an error or terminating the method 200. For example, the error or such terminating may occur when the call from the API has failed so this workflow exits in an error condition to be handled by the computing instance 106.

Step 7 involves the computing instance 106 aligning a formality style to a translation locale. This alignment may occur by the computing instance 106 checking if a style guide for formality is assigned to the target locale, as referenced above pursuant to the data structure 300. This check enables mapping of the language's formal/informal forms to the enumeration, as referenced above pursuant to the data structure 300. For example, Japanese language has three different formal forms so the computing instance 106 would map to one of them here.

Step 8 involves the computing instance 106 determines whether a formality style is defined, pursuant to the data structure 300. If yes, then step 9 is performed (e.g., generating a prompt for the LLM 114). If not, then step 11 is performed (e.g., check for a next style guide field).

Step 9 involves the computing instance 106 generating a prompt for a specific formality style for submission to the LLM 114, pursuant to the data structure 300. This generation may include an input, whether as a single input or a series of inputs, containing a source string (e.g., SourceText), an MT string (e.g., TranslationText), and a formality identifier (e.g., formal or informal). The prompt is submitted to the LLM 114 to receive a corresponding response. One example of such prompt is shown below having “input”: “Source: % s, Translation: % s” % (Source Text, TranslationText), “instruction”: “write the Translation in formal form,” as exemplified by an input and an output below.

| | |
|---|---|
| SourceText | ‘You are an awesome leader for Singapore.’ |
| TranslationText | [symbol] |
| Formality | Formal |
| LLM output | [symbol] |

Step 10 involves the computing instance 106 generating a translation sub-workflow, pursuant to FIG. 4. Note that steps 7-10 may be omitted or performed later in the method 200.

Step 11 involves the computing instance 106 aligning a gender style to a translation locale. This alignment may occur by the computing instance 106 checking if a style guide for gender is assigned to the target locale, as referenced above. Note that some languages may not be affected by gender style rules.

Step 12 involves the computing instance 106 determining whether a gender style is defined, pursuant to the data structure 300. If yes, then step 13 is performed (e.g., generating a prompt for the LLM 114). If not, then step 15 is performed (e.g., check for a next style guide field).

Step 13 involves the computing instance 106 generating a prompt for a specific gender style for submission to the LLM 114, pursuant to the data structure 300. This generation may include an input, whether as a single input or a series of inputs, containing a source string (e.g., SourceText), an MT string (e.g., TranslationText), and a gender identifier (e.g., feminine, masculine, gender neutral). The prompt is submitted to the LLM 114 to receive a corresponding response. One example of such prompt is shown below having “prompt”: “Given this Source: % s and this Translation: % s, return a grammatically correct % s translation in % s” % (SourceText, TranslationText, Gender, TargetLang), as exemplified by an input and an output below.

| | |
|---|---|
| SourceText | ‘My cousin came over to play yesterday.’ |
| TranslationText | [symbol] |
| Gender | ‘feminine’ |
| LLM Output | [symbol] |

Step 14 involves the computing instance 106 generating a translation sub-workflow, pursuant to FIG. 4. Note that steps 11-14 may be omitted or performed earlier or later in the method 200.

Step 15 involves the computing instance 106 aligning a voice style to a translation locale. This alignment may occur by the computing instance 106 checking if a style guide for voice is assigned to the target locale, as referenced above. Note that some languages may not be affected by this rule so this check can occur in this step.

Step 16 involves the computing instance 106 determining whether a voice style is defined, pursuant to the data structure 300. If yes, then step 17 is performed (e.g., generating a prompt for the LLM 114). If not, then step 19 is performed (e.g., check for a next style guide field).

Step 17 involves the computing instance 106 generating a prompt for a specific voice style for submission to the LLM 114, pursuant to the data structure 300. This generation may include an input, whether as a single input or a series of inputs, containing a source string (e.g., SourceText), an MT string (e.g., TranslationText), and a voice identifier (e.g., active or passive). The prompt is submitted to the LLM 114 to receive a corresponding response. One example of such prompt is shown below having “prompt”: “Given this Source: % s and this Translation: % s, return a grammatically correct translation in % s in the % s voice” % (SourceText, TranslationText, TargetLang, Voice), as exemplified by an input and an output below.

| | |
|---|---|
| SourceText | ‘The boy kicked the ball.’ |
| TranslationText | [symbol] |
| Voice | passive |
| LLM Output | [symbol] |

Step 18 involves the computing instance 106 generating a translation sub-workflow, pursuant to FIG. 4. Note that steps 15-18 may be omitted or performed earlier or later in the method 200.

Step 19 involves the computing instance 106 aligning an abbreviation style to a translation locale. This alignment may occur by the computing instance 106 checking if a style guide for abbreviations is assigned to the target locale. Note that some languages may not be affected by this rule so this check can occur in this step.

Step 20 involves the computing instance 106 determining whether an abbreviation style is defined, pursuant to the data structure 300. If yes, then step 21 is performed (e.g., generating a prompt for the LLM 114). If not, then step 23 is performed (e.g., check for a next style guide field).

Step 21 involves the computing instance 106 generating a prompt for a specific abbreviation style for submission to the LLM 114, pursuant to the data structure 300. This generation may include an input, whether as a single input or a series of inputs, containing a source string (e.g., SourceText), an MT string (e.g., TranslationText), and an abbreviation identifier (e.g., acceptable or unacceptable). The prompt is submitted to the LLM 114 to receive a corresponding response. One example of such prompt is shown below having “prompt”: “Given this Source: % s and this Translation: % s, return a grammatically correct translation in % s with abbreviations being % s” % (SourceText, TranslationText, TargetLang, abbre), as exemplified by an input and an output below.

| | |
|---|---|
| SourceText | ‘I like vegetables with seeds (i.e. tomatoes, |
| | zucchinis, etc.)’ |
| TranslationText | [symbol] [symbol] |
| | etc.)’ |
| Abbreviations | acceptable |
| LLM Output | [symbol] [symbol] |
| | etc.).’ |

Step 22 involves the computing instance 106 generating a translation sub-workflow, pursuant to FIG. 4. Note that steps 19-22 may be omitted or performed earlier or later in the method 200.

Step 23 involves the computing instance 106 aligning a colloquial expression style to a translation locale. This alignment may occur by the computing instance 106 checking if a style guide for colloquial expression is assigned to the target locale.

Step 24 involves the computing instance 106 determining whether a colloquial expression style is defined, pursuant to the data structure 300. If yes, then step 25 is performed (e.g., generating a prompt for the LLM 114). If not, then step 27 is performed (e.g., check for a next style guide field).

Step 25 involves the computing instance 106 generating a prompt for a specific colloquial expression style for submission to the LLM 114, pursuant to the data structure 300. This generation may include an input, whether as a single input or a series of inputs, containing a source string (e.g., SourceText), an MT string (e.g., TranslationText), and a colloquial expression identifier (e.g., colloquial or uncolloquial). The prompt is submitted to the LLM 114 to receive a corresponding response. One example of such prompt is shown below having “prompt”: “Given this Source: % s and this Translation: % s, return a grammatically correct % s translation in % s.” % (SourceText, TranslationText, Colloquial, TargetLang), as exemplified by an input and an output below.

| | |
|---|---|
| SourceText | ‘Having met in order to conclude the Uruguay Round of Multilateral |
| | Trade Negotiations, representatives of the governments and of the |
| | European Communities, members of the Trade Negotiations |
| | Committee, agree that the Agreement Establishing the World Trade |
| | Organization (referred to in this Final Act as the “WTO Agreement”), the |
| | Ministerial Declarations and Decisions, and the Understanding on |
| | Commitments in Financial Services, as annexed hereto, embody the |
| | results of their negotiations and form an integral part of this Final Act.’ |
| TranslationText | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] [symbol] |
| Colloquial | colloquial |
| LLM Output | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] [symbol] |
| | [symbol] |

Step 26 involves the computing instance 106 generating a translation sub-workflow, pursuant to FIG. 4. Note that steps 23-26 may be omitted or performed earlier or later in the method 200.

Step 27 involves the computing instance 106 aligning a profanity style to a translation locale. This alignment may occur by the computing instance 106 checking if a style guide for profanity is assigned to the target locale.

Step 28 involves the computing instance 106 determining whether a profanity style is defined, pursuant to the data structure 300. If yes, then step 28 is performed (e.g., generating a prompt for the LLM 114). If not, then step 33 is performed.

Step 29 involves the computing instance 106 attempting to find profanity terms in a source text by searching the source text. This attempt may occur by the computing instance 106 loading a profanity term stem list for the source locale based on the data structure 300, tokenizing the source text, lemmatizing and/or stemming the tokens to reduce every word in the string to their stems, searching the source stems to align them with the profanity term stems sourced from the profanity term stem list, and returning a collection of zero or more profanity terms that were aligned in the source text.

Step 30 involves the computing instance 106 determines whether one or more profane words were found in an output from step 29. If yes, then step 31 is performed. If no (e.g., if a collection of profane words is empty), then step 33 is performed.

Step 31 involves the computing instance 106 generating a prompt for a specific profanity style for submission to the LLM 114, pursuant to the data structure 300. This generation may include an input, whether as a single input or a series of inputs, containing a source string (e.g., SourceText), an MT string (e.g., TranslationText), and a profanity identifier (e.g., preserved or removed). The prompt is submitted to the LLM 114 to receive a corresponding response. One example of such prompt is shown below having “prompt”: “Given this Source: % s and this Translation: % s, return a grammatically correct translation in % s while profanity is % s.” % (SourceText, TranslationText, TargetLang, Profanity), as exemplified by an input and an output below.

| | |
|---|---|
| SourceText | ‘President Yacob is a [symbol] leader for Singapore.’ |
| TranslationText | [symbol] [symbol] |
| Profanity | removed |
| LLM Output | [symbol] [symbol] |

Step 32 involves the computing instance 106 generating a translation sub-workflow, pursuant to FIG. 4. Note that steps 27-32 may be omitted or performed earlier or later in the method 200.

Step 33 involves the computing instance 106 completing the method 200. At this point, the computing instance 106 may output the translation to the computing terminal 104 responsive to the translation request from step 1, or another data source (e.g., an API), whether internal or external to the computing instance 106. This translation can be consumed (e.g., displayed, printed, shared, messaged, emailed, stored) on the computing terminal 104.

FIG. 4 shows a flowchart of an embodiment of an algorithm for receiving a translation according to this disclosure. In view of the method 200 of FIG. 2 and the data structure 300 of FIG. 4, the method 400 includes steps 1-8 performed by the computing instance 106 to validate, i.e., return a pass/reject state identifier of whether an input into the method 400 is valid or not.

Step 1 involves the computing instance submitting a request to the LLM 114 to generate a translation of a source text, as modified by the LLM 114 from a prior respective step in the method 200. The request contains an input, whether as a single input or a series of inputs a source text (e.g., an input text to be translated), a source locale ID (e.g., a modified ISO-639 language code and a modified ISO-3166 country code representing a source text locale), a target locale ID (e.g., a modified ISO-639 (or another standard) language code and a modified ISO-3166 (or another standard) country code representing a desired locale to use for a translation), and a previous translation text (e.g., a translation text before a new translation text is generated).

Step 2 involves the computing instance 106 fetching a translation from the LLM 114 via a prompt. This fetching may occur by the computing instance 106 fetching the set of credentials and metadata for the LLM 114 to be able to execute an call into an API (e.g., a REST API). This metadata may include a uniform resource identifier (URI) (e.g., “https://api.openai.com/v1/completions”), an API key or other credentials, a model name (e.g., “text-davinci-003”), a timeout configuration, a maximum output token length, a maximum output token length value, a temperature, an LLM parameter (e.g., top-k, top-p), a frequency penalty identifier, a presence penalty identifier, or other suitable metadata, or avoid doing so if the computing instance 106 is already signed into the LLM 114, which may be from the method 200. The computing instance 106 may execute an API call (e.g., a REST API) call to the LLM 114 with the prompt and metadata as an input. The computing instance 106 may transform the results of the API call into the input for step 3. This transformation may include cases where the computing instance 106 may receive a 200 response and all error cases.

Step 3 involves the computing instance 106 determining whether the response length is within a set threshold to original text. For example, the computing instance 106 determines whether the response string length within a set threshold of the original string (e.g., within 10% of the original string). Note that blank strings may fail. If yes, then step 4 is performed. If not, then step 8 is performed.

Step 4 involves the computing instance 106 determining whether a translation error rate (TER) score is within a set threshold (e.g., 10% within the length of the style guide data structure difference in characters between the MT and the string returned from LLM 114). If yes, then step 4 is performed. If not, then step 7 is performed.

Step 5 involves the computing instance 106 determining whether the response and the incoming translation are semantically similar to each other. The computing instance 106 may convert the translation text and the previous translation text into vector embeddings and calculate their cosine similarities to find their semantic similarities, such as whether the cosine similarity is within or above or below a threshold range (e.g., above 70% but below a ceiling value). If yes, then step 6 is performed. If not, then step 7 is performed.

Step 6 involves the computing instance 106 determining whether the response and the source text are semantically similar to each other. The computing instance 106 may convert the translation text and the source text into vector embeddings and calculate their cosine similarities to find their semantic similarities, such as whether the cosine similarity is within or above or below a threshold range (e.g., above 70% but below a ceiling value).

Step 7 involves the computing instance 106 returning a new translation. This return may occur if steps 3-6 are yes and the string returned by the LLM 114 passes validation and the computing instance 106 returns the new translation.

Step 8 involves the computing instance 106 returning a previous translation. This return may occur if any check fails (e.g., steps 3-6), then the string is rejected and the previous translation (e.g., before step 1 of the process 400) is returned.

Based on the method 200 or the method 400, the computing instance 106 may be programmed to: (i) submit a source text, a source locale identifier, a target locale identifier, a source style guide identifier, and a target style guide identifier to a data source, such that the data source outputs a first expectation identifier for a first linguistic feature in a target language and a second expectation identifier for a second linguistic feature in the target language based on the source text, the source locale identifier, the target locale identifier, the source style guide identifier, and the target style guide identifier, as per step 2; (ii) access a target text translated from the source text, as per steps 3 or 4; (iii) determine whether (a) a first style guide associated with the first expectation identifier is assigned to the target locale identifier and (b) the target text is not compliant with the first style guide, as per steps 7, 11, 15, 19, 23, or 27; (iv) based on (a) the first style guide being determined to be assigned to the target locale identifier and (b) the target text being determined to not be compliant with the first style guide, as per steps 8, 12, 16, 20, 24, or 28: input the source text, the target text, the first expectation identifier, and a first instruction into a LLM, such that the LLM outputs the target text modified according to the first style guide for the first linguistic feature based on the first instruction to be consistent with the first expectation identifier, as per steps 9, 13, 17, 21, 25, or 31; determine whether (a) a second style guide associated with the second expectation identifier is assigned to the target locale identifier and (b) the target text modified according to the first style guide is not compliant with the second style guide, as per steps 7, 11, 15, 19, 23, or 27; based on (a) the second style guide being determined to be assigned to the target locale identifier and (b) the target text modified according to the first style guide being determined to not be compliant with the first style guide, as per steps 8, 12, 16, 20, 24, or 28: input the source text, the target text modified according to the first style guide, the second expectation identifier, and a second instruction into the LLM, such that the LLM outputs the target text modified according to the first style guide and further modified according to the second style guide for the second linguistic feature based on the second instruction to be consistent with the second expectation identifier, as per steps 9, 13, 17, 21, 25, or 31; (v) based on (a) the first style guide being determined to not be assigned to the target locale identifier or (b) the target text being determined to be compliant with the first style guide, as per steps 7, 11, 15, 19, 23, or 27: determine whether (a) the second style guide is assigned to the target locale identifier and (b) the target text is not compliant with the second style guide, as per steps 8, 12, 16, 20, 24, or 28; based on (a) the second style guide being determined to be assigned to the target locale identifier and (b) the target text being determined to not be compliant with the second style guide, as per steps 7, 11, 15, 19, 23, or 27 or as per steps 8, 12, 16, 20, 24, or 28: input the source text, the target text, the second expectation identifier, and the second instruction into the LLM, such that the LLM outputs the target text modified according to the second style guide for the second linguistic feature based on the second instruction to be consistent with the second expectation identifier, as per steps 9, 13, 17, 21, 25, or 31. The data source may be internal or external to the computing instance 106. The data source may be an API, which may be a REST API. The API may be internal or external to the computing instance 106. The API may be external to the computing instance 106. The target text may be translated from the source text by the MT service 110. The MT service 110 may be internal or external to the computing instance 106. The MT service 110 may be network-based. The source locale identifier may include a language code. The source locale identifier may include a country code. The target locale identifier may include a language code. The target locale identifier may include a country code. Each of the source locale identifier and the target locale identifier may include a language code and a country code. The source style guide identifier may identify a formality style guide, a gender style guide, a voice style guide, an abbreviation style guide, a colloquial expression style guide, or a profanity style guide. The target style guide identifier may identify a formality style guide, a gender style guide, a voice style guide, an abbreviation style guide, a colloquial expression style guide, or a profanity style guide. The first linguistic feature may be formality, where the first expectation identifier identifies a formal expectation or an informal expectation. The first linguistic feature may be target audience, where the first expectation identifier identifies a self expectation, a peer expectation, a senior expectation, or a junior expectation. The first linguistic feature may be gender, where the first expectation identifier identifies a feminine expectation, a masculine expectation, or a gender neutral expectation. The first linguistic feature may be colloquialism, where the first expectation identifier identifies an appropriate expectation or an inappropriate expectation. The first linguistic feature may be voice, where the first expectation identifier identifies an active expectation, a middle expectation, or a passive expectation. The first linguistic feature may be abbreviation, where the first expectation identifier identifies an acceptable expectation or an unacceptable expectation. The first linguistic feature may be profanity, where the first expectation identifier identifies a preserved expectation or a removed expectation. The first style guide may be industry specific. The second style guide may be industry specific. The first style guide may be stored in a data file, a database record, or a tabular format. The second style guide may be stored in a data file, a database record, or a tabular format. The source text, the target text, the first expectation identifier, and the first instruction may be input into the LLM 114 through a chatbot, which may be internal or external to the computing instance 102. The LLM 114 may be internal or external to the computing instance 102. The computing instance 102 may be programmed to: based on (a) the second style guide being determined to not be assigned to the target locale identifier or (b) the target text modified according to the first style guide being determined to be compliant with the first style guide: determine whether (a) a third style guide is assigned to the target locale identifier and (b) the target text is not compliant with the third style guide; and take an action based on the third style guide being determined to be assigned to the target locale identifier and (b) the target text being determined to not be compliant with the third style guide. The action may be to iterate through all style guides listed in a set of style guides (e.g., the data structure 300) for a set of linguistic features and iteratively prompt the LLM 114 to modify a respective target text according to a respective style guide for a respective linguistic feature according to a respective instruction, where the set of style guides contains the first style guide, the second style guide, the third style guide, and a fourth style guide. The target text may be validated before determining whether (a) the second style guide associated with the second expectation identifier is assigned to the target locale identifier and (b) the target text modified according to the first style guide is not compliant with the second style guide. The target text may be validated based on a length of a content in a response received from the LLM 114. The target text may be validated based on a translation error rate of a content within a response received from the LLM 114. The target text may be validated based on a semantic similarity of a content of a response received from the LLM 114 relative to the content and the target text. The target text may be validated based on a semantic similarity of a content of a response received from the LLM 114 relative to the content and the source text. The target text may be validated based on at least two of (1) a length of a content in a response received from the LLM 114, (2) a translation error rate of a content within a response received from the LLM 114, (3) a semantic similarity of a content of a response received from the LLM 114 relative to the content and the target text, or (4) a semantic similarity of a content of a response received from the LLM 114 relative to the content and the source text. The target text may be validated based on at least three of (1) a length of a content in a response received from the LLM 114, (2) a translation error rate of a content within a response received from the LLM 114, (3) a semantic similarity of a content of a response received from the LLM 114 relative to the content and the target text, or (4) a semantic similarity of a content of a response received from the LLM 114 relative to the content and the source text. The target text may be validated based on (1) a length of a content in a response received from the LLM 114, (2) a translation error rate of a content within a response received from the LLM 114, (3) a semantic similarity of a content of a response received from the LLM 114 relative to the content and the target text, and (4) a semantic similarity of a content of a response received from the LLM 114 relative to the content and the source text. The computing instance 102 may be programmed to serve a content for consumption to the computing terminal 104, where the content is based on (1) the target text modified according to the first style guide and further modified according to the second style guide for the second linguistic feature based on the second instruction to be consistent with the second expectation identifier or (2) the target text modified according to the second style guide for the second linguistic feature based on the second instruction to be consistent with the second expectation identifier. The second linguistic feature may be formality, wherein the second expectation identifier identifies a formal expectation or an informal expectation. The second linguistic feature may be target audience, where the second expectation identifier identifies a self expectation, a peer expectation, a senior expectation, or a junior expectation. The second linguistic feature is gender, where the second expectation identifier identifies a feminine expectation, a masculine expectation, or a gender neutral expectation. The second linguistic feature may be colloquialism, wherein the second expectation identifier identifies an appropriate expectation or an inappropriate expectation. The second linguistic feature may be voice, where the second expectation identifier identifies an active expectation, a middle expectation, or a passive expectation. The second linguistic feature may be abbreviation, where the second expectation identifier identifies an acceptable expectation or an unacceptable expectation. The second linguistic feature may be profanity, where the second expectation identifier identifies a preserved expectation or a removed expectation. The first linguistic feature and the second linguistic feature may be different from each other and may be selected from a set containing at least two of formality, target audience, gender, colloquialism, voice, abbreviation, or profanity. The first linguistic feature and the second linguistic feature may be selected from the set containing at least three of formality, target audience, gender, colloquialism, voice, abbreviation, or profanity. The first linguistic feature and the second linguistic feature may be selected from the set containing at least four of formality, target audience, gender, colloquialism, voice, abbreviation, or profanity. The first linguistic feature and the second linguistic feature may be selected from the set containing at least five of formality, target audience, gender, colloquialism, voice, abbreviation, or profanity. The first linguistic feature and the second linguistic feature may be selected from the set containing at least six of formality, target audience, gender, colloquialism, voice, abbreviation, or profanity. The first linguistic feature and the second linguistic feature may be selected from the set containing formality, target audience, gender, colloquialism, voice, abbreviation, and profanity. The source text may be structured or unstructured. The target text may be structured or unstructured. Similar programming may of the computing instance 106 may enable a method do operate the computing instance 106, as per foregoing, or a storage medium (e.g., a memory, a persistent memory) storing a set of instructions executable by the computing instance 106 to perform the method, as per foregoing.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical molecule, a chemical composition, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

What is claimed is:

1. A system, comprising:
a computing instance programmed to:
(i) submit a source text, a source locale identifier, a target locale identifier, a source style guide identifier, and a target style guide identifier to a data source, such that the data source outputs a first expectation identifier for a first linguistic feature in a target language and a second expectation identifier for a second linguistic feature in the target language based on the source text, the source locale identifier, the target locale identifier, the source style guide identifier, and the target style guide identifier;
(ii) access a target text translated from the source text;
(iii) determine whether (a) a first style guide associated with the first expectation identifier is assigned to the target locale identifier and (b) the target text is not compliant with the first style guide;
(iv) based on (a) the first style guide being determined to be assigned to the target locale identifier and (b) the target text being determined to not be compliant with the first style guide:
input the source text, the target text, the first expectation identifier, and a first instruction into a large language model (LLM), such that the LLM outputs the target text modified according to the first style guide for the first linguistic feature based on the first instruction to be consistent with the first expectation identifier;
determine whether (a) a second style guide associated with the second expectation identifier is assigned to the target locale identifier and (b) the target text modified according to the first style guide is not compliant with the second style guide;
based on (a) the second style guide being determined to be assigned to the target locale identifier and (b) the target text modified according to the first style guide being determined to not be compliant with the first style guide:
input the source text, the target text modified according to the first style guide, the second expectation identifier, and a second instruction into the LLM, such that the LLM outputs the target text modified according to the first style guide and further modified according to the second style guide for the second linguistic feature based on the second instruction to be consistent with the second expectation identifier;
(v) based on (a) the first style guide being determined to not be assigned to the target locale identifier or (b) the target text being determined to be compliant with the first style guide:
determine whether (a) the second style guide is assigned to the target locale identifier and (b) the target text is not compliant with the second style guide;
based on (a) the second style guide being determined to be assigned to the target locale identifier and (b) the target text being determined to not be compliant with the second style guide:
input the source text, the target text, the second expectation identifier, and the second instruction into the LLM, such that the LLM outputs the target text modified according to the second style guide for the second linguistic feature based on the second instruction to be consistent with the second expectation identifier.

2. The system of claim 1, wherein the source style guide identifier identifies a formality style guide, a gender style guide, a voice style guide, an abbreviation style guide, a colloquial expression style guide, or a profanity style guide.

3. The system of claim 1, wherein the target style guide identifier identifies a formality style guide, a gender style guide, a voice style guide, an abbreviation style guide, a colloquial expression style guide, or a profanity style guide.

4. The system of claim 1, wherein the first linguistic feature is formality, wherein the first expectation identifier identifies a formal expectation or an informal expectation.

5. The system of claim 1, wherein the first linguistic feature is target audience, wherein the first expectation identifier identifies a self expectation, a peer expectation, a senior expectation, or a junior expectation.

6. The system of claim 1, wherein the first linguistic feature is gender, wherein the first expectation identifier identifies a feminine expectation, a masculine expectation, or a gender neutral expectation.

7. The system of claim 1, wherein the first linguistic feature is colloquialism, wherein the first expectation identifier identifies an appropriate expectation or an inappropriate expectation.

8. The system of claim 1, wherein the first linguistic feature is voice, wherein the first expectation identifier identifies an active expectation, a middle expectation, or a passive expectation.

9. The system of claim 1, wherein the first linguistic feature is abbreviation, wherein the first expectation identifier identifies an acceptable expectation or an unacceptable expectation.

10. The system of claim 1, wherein the first linguistic feature is profanity, wherein the first expectation identifier identifies a preserved expectation or a removed expectation.

11. The system of claim 1, wherein the computing instance is programmed to:
based on (a) the second style guide being determined to not be assigned to the target locale identifier or (b) the target text modified according to the first style guide being determined to be compliant with the first style guide:
determine whether (a) a third style guide is assigned to the target locale identifier and (b) the target text is not compliant with the third style guide; and
take an action based on the third style guide being determined to be assigned to the target locale identifier and (b) the target text being determined to not be compliant with the third style guide.

12. The system of claim 11, wherein the action is to iterate through all style guides listed in a set of style guides for a set of linguistic features and iteratively prompt the LLM to modify a respective target text according to a respective style guide for a respective linguistic feature according to a respective instruction, wherein the set of style guides contains the first style guide, the second style guide, the third style guide, and a fourth style guide.

13. The system of claim 1, wherein the target text is validated before determining whether (a) the second style guide associated with the second expectation identifier is assigned to the target locale identifier and (b) the target text modified according to the first style guide is not compliant with the second style guide.

14. The system of claim 13, wherein the target text is validated based on a length of a content in a response received from the LLM.

15. The system of claim 13, wherein the target text is validated based on a translation error rate of a content within a response received from the LLM.

16. The system of claim 13, wherein the target text is validated based on a semantic similarity of a content of a response received from the LLM relative to the content and the target text.

17. The system of claim 13, wherein the target text is validated based on a semantic similarity of a content of a response received from the LLM relative to the content and the source text.

18. The system of claim 13, wherein the target text is validated based on at least two of (1) a length of a content in a response received from the LLM, (2) a translation error rate of a content within a response received from the LLM, (3) a semantic similarity of a content of a response received from the LLM relative to the content and the target text, or (4) a semantic similarity of a content of a response received from the LLM relative to the content and the source text.

19. The system of claim 18, wherein the target text is validated based on at least three of (1) a length of a content in a response received from the LLM, (2) a translation error rate of a content within a response received from the LLM, (3) a semantic similarity of a content of a response received from the LLM relative to the content and the target text, or (4) a semantic similarity of a content of a response received from the LLM relative to the content and the source text.

20. The system of claim 19, wherein the target text is validated based on (1) a length of a content in a response received from the LLM, (2) a translation error rate of a content within a response received from the LLM, (3) a semantic similarity of a content of a response received from the LLM relative to the content and the target text, and (4) a semantic similarity of a content of a response received from the LLM relative to the content and the source text.

21. The system of claim 1, wherein the computing instance is programmed to serve a content for consumption to a computing terminal, wherein the content is based on (1) the target text modified according to the first style guide and further modified according to the second style guide for the second linguistic feature based on the second instruction to be consistent with the second expectation identifier or (2) the target text modified according to the second style guide for the second linguistic feature based on the second instruction to be consistent with the second expectation identifier.

22. The system of claim 1, wherein the second linguistic feature is formality, wherein the second expectation identifier identifies a formal expectation or an informal expectation.

23. The system of claim 1, wherein the second linguistic feature is target audience, wherein the second expectation identifier identifies a self expectation, a peer expectation, a senior expectation, or a junior expectation.

24. The system of claim 1, wherein the second linguistic feature is gender, wherein the second expectation identifier identifies a feminine expectation, a masculine expectation, or a gender neutral expectation.

25. The system of claim 1, wherein the second linguistic feature is colloquialism, wherein the second expectation identifier identifies an appropriate expectation or an inappropriate expectation.

26. The system of claim 1, wherein the second linguistic feature is voice, wherein the second expectation identifier identifies an active expectation, a middle expectation, or a passive expectation.

27. The system of claim 1, wherein the second linguistic feature is abbreviation, wherein the second expectation identifier identifies an acceptable expectation or an unacceptable expectation.

28. The system of claim 1, wherein the second linguistic feature is profanity, wherein the second expectation identifier identifies a preserved expectation or a removed expectation.

29. The system of claim 1, wherein the first linguistic feature and the second linguistic feature are different from each other and are selected from a set containing at least two of formality, target audience, gender, colloquialism, voice, abbreviation, or profanity.
